(19) United States
(12) Patent Application Publication
(10) Pub. No.: US 2009/0077928 A1
(43) Pub. Date: Mar. 26, 2009

(54) METHOD FOR OVERPRINTING ALREADY PRINTED PACKAGES

(75) Inventor: Yves Ismael, Nice (FR)

Correspondence Address: YOUNG & THOMPSON, 209 Madison Street, Suite 500, ALEXANDRIA, VA, 22314, US

(73) Assignee: OVERPRINT INDUSTRIE, Antibes (FR)

(21) Appl. No.: 11/663,444

(22) PCT Filed: Sep. 21, 2005
(86) PCT No.: PCT/EP2005/054728

§ 371 Date: Nov. 5, 2008

(30) Foreign Application Priority Data
Sep. 22, 2004 (FR) 0452122

(51) Int. Cl. B41F 17/16; B41F 17/24

(52) U.S. Cl. 53/411

(57) ABSTRACT

Method for overprinting already printed packages includes preparing a raster or steel magnetic block which is provided with a clamping plate, wherein the block is engraved with the aid of a jet etching device and represents new texts or patterns which are applicable by tampon printing using specific inks on a located existing and already printed part of a box, drying, verifying and packing the box. The method is used for overprinting and includes masking an undesired area by printing a blanking pavement and afterwards by overprinting a desired text, instruction or a pattern thereon and uses an automatic line including a de-stacker (3) for automatically feeding boxes, at least one printing head (1), at least one drying tunnel (4) and at least one restacker (5).

The object of the invention is a process intended more specifically for overprinting of already printed packages.

The printing applies especially to corrections, additions, and/or changes on packages.

The invention makes it possible to correct a printing error. It allows a package to be re-used.

These packages to be corrected can be found especially in foodstuffs and large-scale retailing, industry, perfumery, cosmetology, and, finally, pharmacy.

The prior art can be defined by the following patents:

FR.2,739,805: This invention relates to a process designed more specifically for overprinting and consists in blanking, by pad printing, with specific inks, an already printed existing medium for purposes of overprinting a text or a design.

This process comprises the use of pad printing machines in an automated context. The media are stored in a distributor, then, according to an electronically managed rhythm, are taken by a conveyor to an automatic printer. At this stage, the media are positioned on various printing and heating stations for purposes of their overprinting. When the media have undergone all the different phases of the operation, they are discharged into a container in which they are counted.

FR.2,790,996: This process comprises the use of pad printing machines in an automated context. The media are stored in a supply cart. Then, using a manipulator arm, the media are positioned on various printing heads to be overprinted. When the media have undergone all the different phases of the operation, they are discharged onto the removal plane where they are manipulated by the operators.

WO 03 093379: The invention relates to a covering composition used as a veneer covering that contains an alkyd resin, with an average molecular mass of between roughly 500 and 2,000, and with polydispersivity of less than roughly 2. Once rebaked, this composition is essentially stable from the standpoint of color. It is essentially flexible and can be used as a veneer on a container body. The invention likewise relates to a substrate covered by said composition.

JP 2001 232980: Problem to be resolved: To provide an overprinted card of low cost and a production method in which the cost of materials is reduced and in which the production rate of the overprinted cards is improved.

Solution: In the overprinted card composed of a center part, an upper part, a magnetic card, a closing layer, a print layer, and a protective layer, it is specified that the center part 11 is a white, opaque sheet and the upper sheet 13 is a transparent sheet.

U.S. Pat. No. 6,098,541: Overprinting embosser composed of three print surface retaining portions located facing one another under non-hollow area conditions, each portion of the print surface comprising an expanded thermoplastic sheet attached to each print surface retaining portion, a portion for supporting the print surface retaining portions that can slide rotationally by means of a generally movable, resistant hinge, and a guide bar for guiding the direction of the sliding portions. Moreover, so as to control the position in which the sliding portions are stopped such that each print surface portion is positioned at a predetermined printing position, there are three grooves on the guide bar, and a spring with a projection corresponding to said grooves is fixed on the sliding portion.

These different inventions have numerous disadvantages, especially the two inventions described in patents FR.2,739,805 and FR.2,790,996. The overprinting is done by a machine that works rotationally relative to two stations. One station blanks the part to be modified; the other station applies the overprint.

This operation, by a machine with two rotary stations, does not allow production rhythms to be accelerated.

The process and the machine for implementing it can overprint 1000 (thousand) pieces per hour, according to the prior art.

According to the invention, the process and the machine make it possible to overprint four to five times more pieces per hour.

The object of the invention is an automated process designed to print existing packages, already printed or not, and solely in the form of cut-out materials.

The process consists in overprinting a text or design, which has been printed with a pad, with specific inks and different colors. These boxes of different materials can be folded and preglued when flat.

This printing process makes it possible to position a correction or print addition at a marked location using the pad printing technique.

Currently, the implementation of this process is determined by manual operations. Besides the limitation of the number of pieces produced per hour, it is difficult to quickly position the box to be treated since manipulations are currently performed by tongs or clamps that manipulate and hold the medium to be printed.

The process according to the invention makes it possible to greatly increase production rhythms and to overprint any location on the flat or glued boxes.

The process designed for printing of already printed packages consists first of all in preparing a screen or steel magnetic block with a fastening sheet; this block engraved using a spray printing device shows the new texts or designs that will be applied by pad printing, with specific inks, an existing marked and already printed part of a box; the box is then dried, checked and packaged; this process is used in overprinting, an operation that consists in covering the site no longer wanted by printing a blanking box, then overprinting the text, the slogan or the desired design, characterized by the fact that it uses an automation line comprising:

an unstacker that allows automatic feed of the boxes

at least one print head

at least one drying tunnel

at least one restacker

manipulation of said boxes is done by a suction circuit and suction cups.

Process characterized by the fact that it uses two automation lines installed in series, a first line for covering or blanking the site that is no longer wanted, a second line for overprinting the text, the slogan and/or the desired design.

According to one preferred embodiment, the print head is attached to sliding stages that allow it to move axially and lengthwise.

According to another characteristic of the invention, the print head can print directly on the unstacker.

For this purpose, the box receiving plate is relatively rigid since the force applied by the pad is 200 working-copy tons, but the lightest possible in order for the drive motor to be able to move it in the desired periods of time.

The box is pushed by a piece of sheet-metal and suctioned by the suction cups. The suction cups are placed under the receiving plate, which allows pad printing on the entire surface of the box.

The receiving plate is provided with several suction cups located under said plate, upstream; the suction cups are rectangular and downstream; the suction cups have a square shape. There are two rectangular suction cups upstream and a dozen square suction cups downstream, the suction cups taking in the air on the receiving plate to properly hold the box before and after printing by the print head, then, immediately after printing, the suction is reversed, the air is discharged by the suction cups, which makes it possible to disengage the box from the receiving plate in order for the latter to drop onto the feed plate of the heating tunnel.

The attached drawings are given by way of example and do not limit the invention. They show only one embodiment of the invention and will allow it to be easily understood.

FIG. 1 is a schematic view of a production line seen from the side.

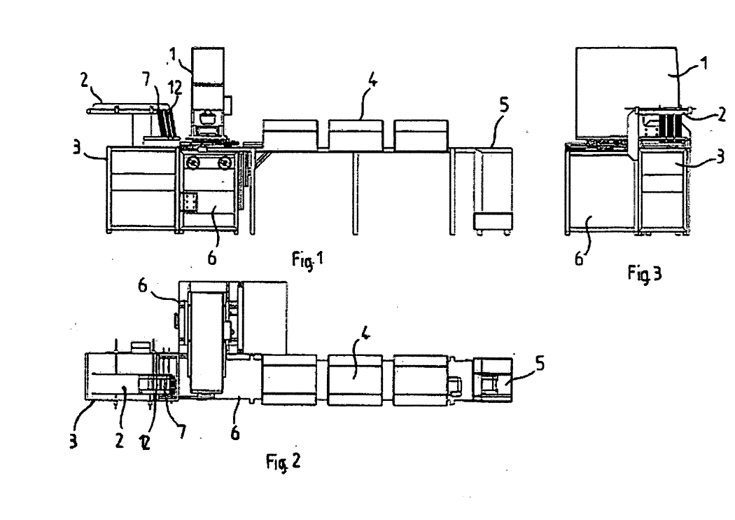

FIG. 2 is a schematic view of a production line seen from overhead.

FIG. 3 is a schematic view of a production line seen from the back of the side of the feed mat.

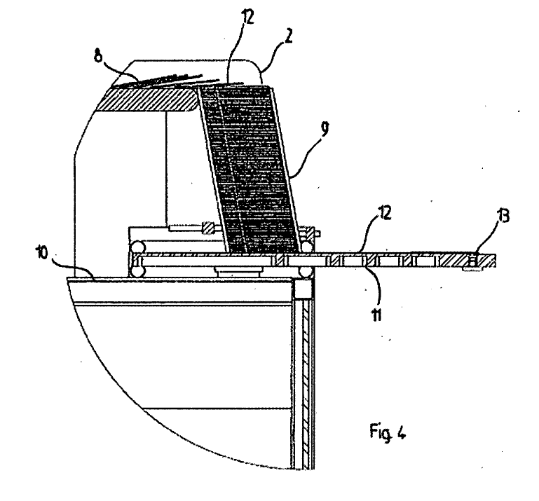

FIG. 4 is a detailed cutaway view of the unstacker.

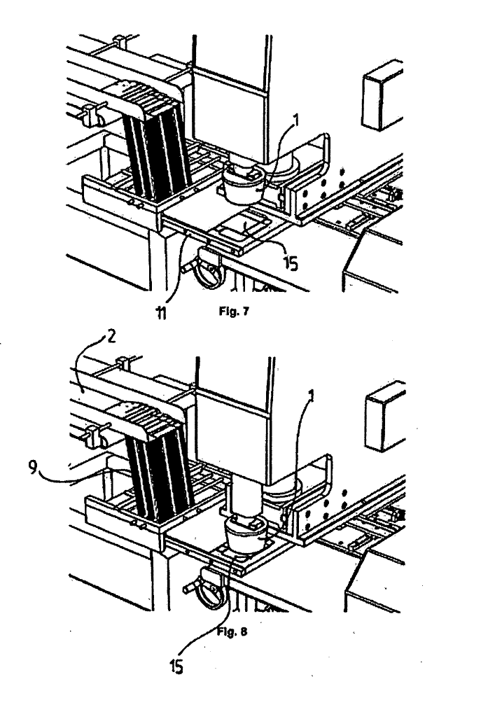

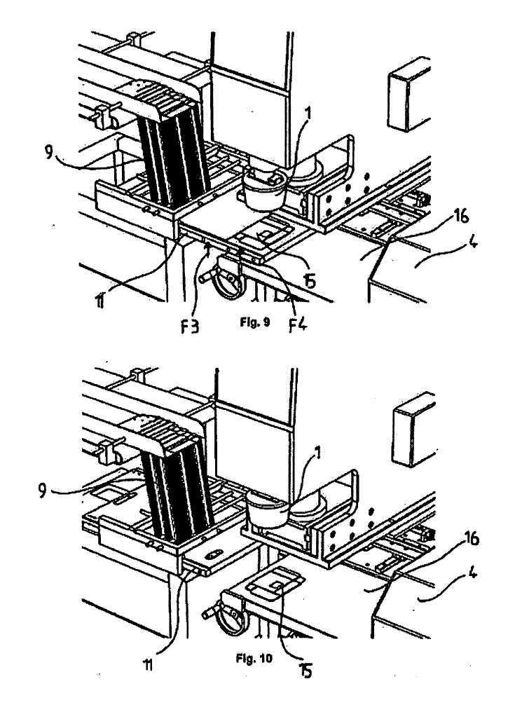

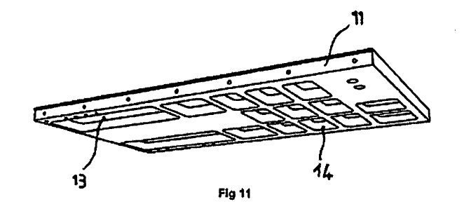

FIGS. 5 to 10 show the overprinting process.

They show especially the movement of the sliding plate.

FIG. 11 is a perspective bottom view of the receiving plates of the boxes to be overprinted.

This invention is innovative by its unstacker system that makes it possible not only to select the boxes one by one in a precise, marked and very rapid manner by virtue of its type of driving, but to allow printing of the box directly on its selection system; the purpose here is to avoid all types of manipulation between the feed unit and the printing zone and to print any location on the box.

With reference to the drawings, the invention includes the following:

the print head 1

the feed mat 2

the unstacker 3

the heating tunnel 4

the restacker 5.

The print head 1 is fixed on the sliding stages 6 that allow it to move axially and longitudinally.

The operator places the boxes on the feed conveyor 2. The boxes are routed to the cage where the guides 8, 9 will have been pre-set to the box format. The plate 11 moves back and forth between the cage and the print head by means of a brushless linear motor 10. In one direction, the box is pushed by the steel sheet with the thickness of the box that will be suctioned by the suction cups 13 during this time. Once the plate is positioned under the print head, pad printing will be done. Once the box is printed, the plate moves back. With the cessation of the suction and the return speed of the plate, the box drops by gravity on the conveyor of the heating tunnel 4. This tunnel is equipped with several drying technologies: one is pulsed hot air and the other is ultraviolet, thus allowing application of several types of ink to the boxes. Once the box is dried, it will be routed to the restacker 5. The restacker allows the boxes to be piled so that the operation can easily box them.

The process is innovative because the print head can directly print on the unstacking system. To do this, it was necessary to devise a relatively rigid plate 11 because the force applied by the pad is 2000 N, but the lightest possible so that the drive motor 10 can move it within the desired periods of time. The box is pushed by a piece of sheet-metal and suctioned by the suction cups 13, 14 (shown in FIG. 11).

The drive motors of the brushless numerical axis type currently allow movements of heavy loads with high speed and high precision. The plate 11 handles fourteen kilograms in our case and moves 35 cm in 0.3 second. The fast return of the plate 11 and cessation of suction are sufficient for the box not to return with the plate to the unstacker 3, and it drops by gravity onto the conveyor 16 of the drying tunnel 4. The complete cycle takes 0.9 second (faster than the print head: 1 s). The blots are made during other operations, which allows a printing rate of 3600 impressions/hour. Since the boxes 15 are suctioned by the bottom, pad printing 1 (print head) can be done on the entire surface of the box.

The operator places the boxes 15 on the feed conveyor 2. The boxes 15 are routed by a rolling mat on the cage on which the guides 8, 9, which have been set to the box format, feed the sliding plate 11. This sliding plate moves back and forth according to arrows F1 and F2 between the cage 12 and the print head 1 by means of a linear motor 10.

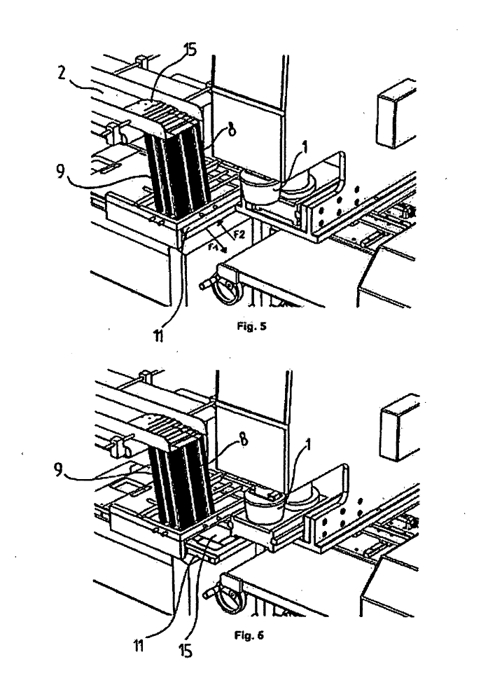

According to arrow F1 shown in FIGS. 5 and 6, the plate 11 will position the box to be printed 15 under the print head 1. Once the plate 11 is properly positioned under the print head 1, printing is done with the pad by vertical displacement of the print head 1.

Once the box 15 has been printed, the plate 11 moves back, according to the arrow F2, the air suctioned by the suction cups is stopped and is reversed according to arrows F3 and F4, shown in FIG. 8, such that the box 15 is lifted off the plate 11 and drops by gravity onto the conveyor 16 of the heating tunnel or drying tunnel 4. This tunnel 4 allows drying of the boxes 15 that will route the dried box 15 to the restacker 5.

### REFERENCES

| | |
|---|---|
| 1. | Print head or pad |
| 2. | Feed conveyor |
| 3. | Boxes |
| 4. | Drying tunnel |
| 5. | Restacker |
| 6. | Sliding stages |
| 7. | Unstacker |
| 8. | Guides |
| 9. | Guides |
| 10. | Motor |
| 11. | Plate |
| 12. | Cage |
| 13., 14. | Suction cups |
| 15. | Boxes |
| 16. | Conveyor |

1. Process intended for overprinting of already printed packages, an operation that consists in covering the site no longer wanted by printing a blanking box, then overprinting the text, the slogan or the desired design, consisting first of all in preparing a screen or steel magnetic block with a fastening sheet; this block engraved using a spray printing device shows the new texts or designs that will be applied by pad printing with specific inks on an existing marked and already printed part of a box; the box (15) is then dried, checked and packaged, characterized by the fact that it uses an automation line comprising: an unstacker (3) that allows automatic feed of the boxes, at least one print head (1), at least one drying tunnel (4), and at least one re-stacker (5).

2. Process according to claim 1, wherein manipulation of said boxes is done by a suction circuit and suction cups.

3. Process according to claim 1, wherein it uses two automation lines installed in series, a first line for covering or blanking the site no longer wanted, a second line for overprinting the text, the slogan and/or the desired design.

4. Process according to claim 1, wherein the print head (1) is attached to sliding stages that allow it to move axially and lengthwise.

5. Process according to claim 4, wherein the print head (1) can print directly on the unstacker (7); for this purpose, the receiving plate (11) of the box (15) is relatively rigid since the force applied by the print head (1) or the pad is 200 newtons, but the lightest possible in order for the drive motor to be able to move it within the desired periods of time.

6. Process according to claim 5, wherein the box (15) is pushed by a piece of sheet-metal and suctioned by the suction cups (13, 14); the suction cups are placed under the receiving plate (11), which allows printing with the pad (1) on the entire surface of the box (15).

7. Process according to claim 6, wherein the receiving plate (11) is provided with several suction cups located under said plate, upstream; the suction cups (13) are rectangular and downstream; the suction cups (14) have a square shape.

8. Process according to claim 6, wherein once the plate (11) is properly positioned under the print head (1), pad printing is done by vertical movement of the print head (1); once the box (15) is printed, the plate (11) moves back; the air suctioned by the suction cups is stopped and is reversed such that the box (15) is lifted off the plate (11) and drops by gravity onto the conveyor (16) of the heating tunnel or drying tunnel (4).

9. Process according to claim 2, wherein it uses two automation lines installed in series, a first line for covering or blanking the site no longer wanted, a second line for overprinting the text, the slogan and/or the desired design.

10. Process according to claim 2, wherein the print head (1) is attached to sliding stages that allow it to move axially and lengthwise.

11. Process according to claim 7, wherein once the plate (11) is properly positioned under the print head (1), pad printing is done by vertical movement of the print head (1); once the box (15) is printed, the plate (11) moves back; the air suctioned by the suction cups is stopped and is reversed such that the box (15) is lifted off the plate (11) and drops by gravity onto the conveyor (16) of the heating tunnel or drying tunnel (4).
